(19) United States
(12) Patent Application Publication
(10) Pub. No.: US 2025/0068813 A1
(43) Pub. Date: Feb. 27, 2025

(54) CO-SIMULATION SUPPORTING SAVE AND RESTART OF DIVERSE SIMULATORS

(71) Applicant: International Business Machines Corporation, Armonk, NY (US)

(72) Inventors: Ronald Cash, Nacogdoches, TX (US); Walter Peter Kowalski, III, Austin, TX (US); Nitin Pundir, Cedar Park, TX (US); Wolfgang Roesner, Austin, TX (US)

(21) Appl. No.: 18/453,060

(22) Filed: Aug. 21, 2023

(51) Int. Cl. G06F 30/3308; G06F 9/54

(52) U.S. Cl. CPC G06F 30/3308; G06F 9/542; G06F 9/544

(57) ABSTRACT

Co-simulation of an integrated circuit design is restarted from a co-simulation snapshot. Execution of a respective co-simulation communicator (CC) process for each of a main co-simulation unit, a first client co-simulation unit, and a second client co-simulation unit is initiated. A first child process is forked from the CC process of the first client co-simulation unit, and a second child process is forked from the CC process of the second client co-simulation unit. Via inter-process communication from the CC process of the main co-simulation unit to the CC process of each of the first and second client co-simulation units, coordinated execution of a cycle-based simulator by the first child process and execution of an event-based simulator by the second child process is restarted. Execution of the cycle-based simulator is restarted from a cycle-based simulation checkpoint, and execution of the event-based simulator is restarted from an event-based simulation snapshot.

### BACKGROUND OF THE INVENTION

The present invention relates in general to data processing, and in particular, to simulation of integrated circuit designs.

Modern integrated circuits (ICs) commonly include millions or billions of components and are extremely time-intensive and expensive to design. As part of the process of designing an IC, designers typically develop a logical hardware model of the integrated circuit. Running a testbench on the hardware model utilizing a simulator enables the operation of the hardware model to be observed under a variety of conditions and checked for logic errors prior to fabrication.

In some design scenarios, multiple different companies may contribute different portions of the overall IC design, for example, through a joint development agreement or licensing arrangement in which one company licenses in an intellectual property (IP) block developed by another company. In such cases, different portions of the IC design may have differing associated hardware models, which may not all be compatible with a common simulator. For example, some hardware models may be developed for processing by a cycle-based simulator, while other hardware models may be developed for processing by an event-based simulator. Further, each of these types of simulators may be designed to run testbenches written in different, incompatible languages.

To facilitate simulation of IC designs represented by multiple diverse hardware models, co-simulation platforms that permit coordination of the concurrent execution of multiple diverse simulators have been developed. One technical need that remains unaddressed in currently available co-simulation platforms is that currently available co-simulation platforms do not support simulation by multiple diverse simulators to be halted at a checkpoint (e.g., in response to detection of an error) and then restarted from the checkpoint. Because simulation of large IC design may take multiple days of processing, the inability to halt and resume simulation at a given checkpoint can undesirably require simulation processing to be restarted at the beginning of the testbench each time simulation processing is halted.

### SUMMARY OF THE INVENTION

In view of the foregoing, the present application provides methods, systems, and program products that enable co-simulation of an integrated circuit design to be saved and resumed at a selected point.

In at least one embodiment, co-simulation of an integrated circuit design is restarted from a co-simulation snapshot. Execution of a respective co-simulation communicator (CC) process for each of a main co-simulation unit, a first client co-simulation unit, and a second client co-simulation unit is initiated. A first child process is forked from the CC process of the first client co-simulation unit, and a second child process is forked from the CC process of the second client co-simulation unit. Via inter-process communication from the CC process of the main co-simulation unit to the CC process of each of the first and second client co-simulation units, coordinated execution of a cycle-based simulator by the first child process and execution of an event-based simulator by the second child process is restarted. Execution of the cycle-based simulator is restarted from a cycle-based simulation checkpoint, and execution of the event-based simulator is restarted from an event-based simulation snapshot.

### BRIEF DESCRIPTION OF THE DRAWINGS

FIG. 1 is a high-level block diagram of an exemplary data processing system in accordance with one embodiment;

FIG. 2 is a more detailed block diagram of an exemplary software environment for co-simulation in accordance with one embodiment;

FIG. 3 illustrates the establishment of co-simulation interval in accordance with one embodiment;

FIG. 4 depicts various processes in a co-simulation environment in accordance with one embodiment;

FIG. 5 is a high-level logical flowchart of an exemplary process for starting co-simulation in accordance with one embodiment;

FIG. 6 is a high-level logical flowchart of an exemplary process for saving a state of a co-simulation in accordance with one embodiment;

FIG. 7 is a data flow diagram of an exemplary process for saving a co-simulation state in accordance with one embodiment; and

FIG. 8 is a high-level logical flowchart of an exemplary process for restarting a co-simulation from a saved co-simulation state in accordance with one embodiment.

### DETAILED DESCRIPTION OF ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as co-simulation platform 200 supporting the concurrent simulation of multiple diverse hardware models by multiple diverse simulators, such as one or more cycle-based simulator(s) 202 and one or more event-based simulator(s) 204. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

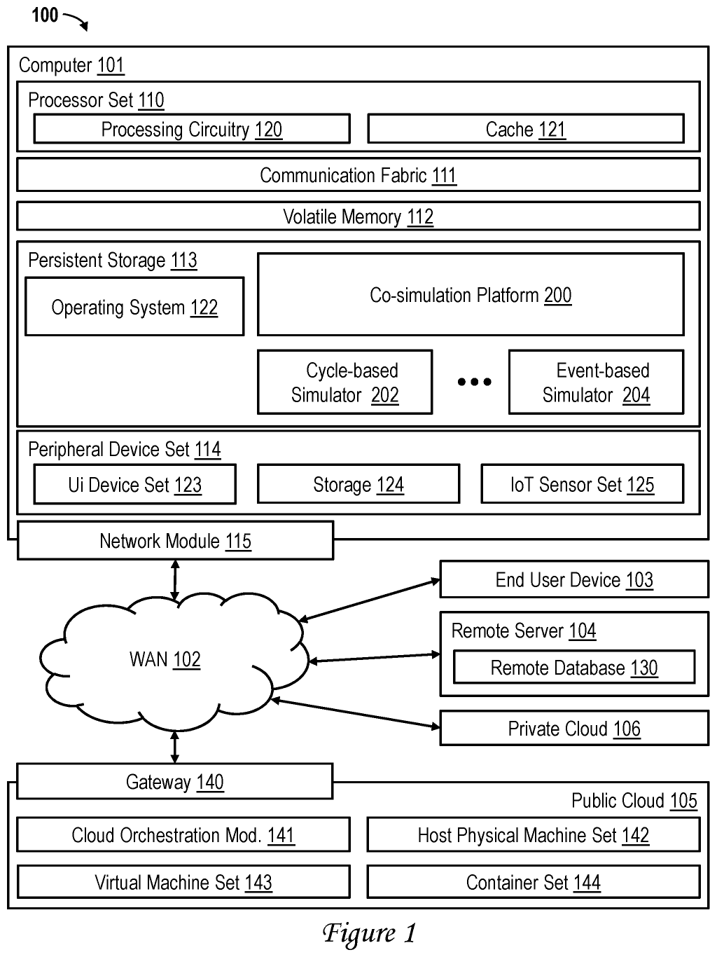

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet-of-Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the Internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Those of ordinary skill in the art will appreciate that the architecture and components of a data processing environment can vary between embodiments. Accordingly, the exemplary computing environment 100 given in FIG. 1 is not meant to imply architectural limitations with respect to the claimed invention.

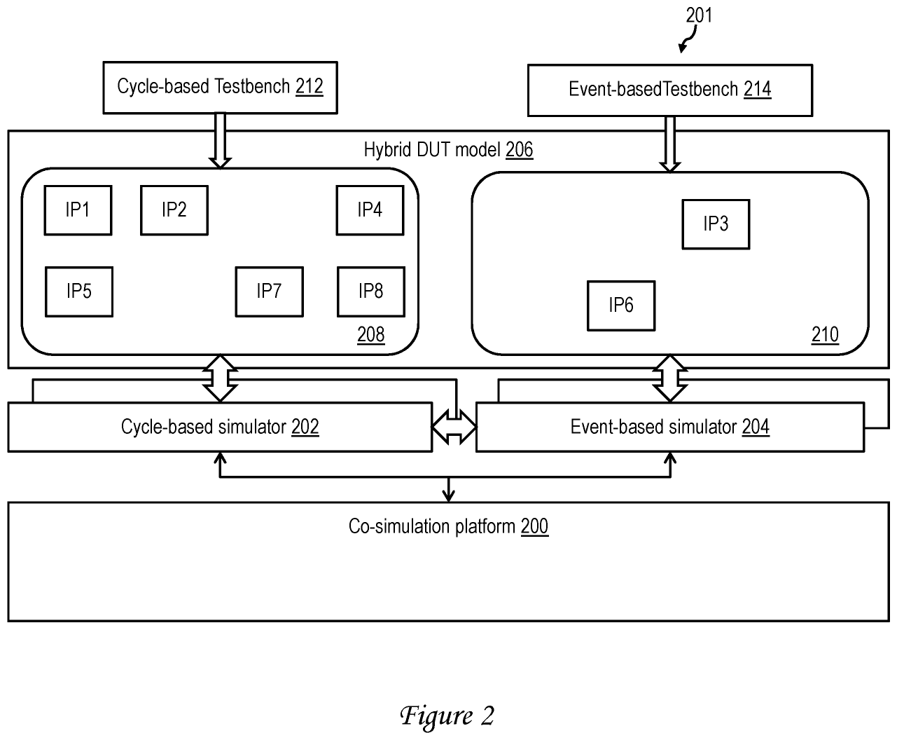

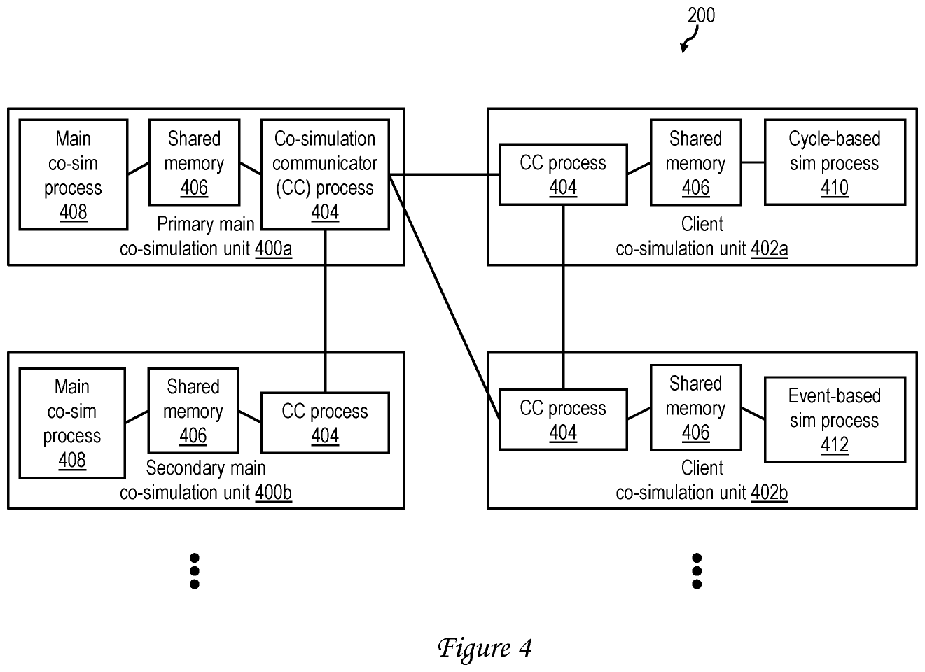

Referring now to FIG. 2, there is depicted a more detailed block diagram of an exemplary software environment 201 for co-simulation in accordance with one embodiment. In the depicted example, co-simulation platform 200 runs one or more cycle-based simulators 202 and one or more event-based simulators 204, for example, in child processes of co-simulation platform 200 as discussed further below with reference to FIG. 4. Although the number of concurrently executing cycle-base simulators 202 and event-based simulators 204 is not restricted, it will hereafter be assumed that co-simulation platform 200 concurrently executes one cycle-based simulator 202 and one event-based simulator 204 for ease of explication.

Co-simulation platform 200 runs cycle-based simulator 202 and event-based simulator 204 in concert to simulate the operation of a IC having a corresponding hardware model referred to herein as hybrid device-under-test (DUT) model 206. As indicated in FIG. 2, hybrid DUT model 208 includes a first logical block set 208 including IP blocks IP1, IP2, IP4, IP5, IP7, and IP8, as well as a second logical block set 210 including IP blocks IP3 and IP6. In some cases, one or more of the IP blocks may be encrypted as stored, for example, in persistent storage 113, remote server 104, or public cloud 105, and only decrypted at runtime. During simulation, the IP blocks in first logical block set 208 are stimulated by a cycle-based testbench 212, and the IP blocks in second logical block set 210 are stimulated by event-based testbench 214.

Because event-based simulator 204 lacks any inherent notion of time as provided by a simulated clock cycle within hybrid DUT model 206 and because the various stages or phases of processing typically differ between cycle-based simulator 202 and event-based simulator 204, co-simulator platform 200 preferably coordinates the simulation of cycle-based simulator 202 and event-based simulator 204 by implementing co-simulation intervals at which cycle-based simulator 202 and event-based simulator 204 synchronize operation by exchanging DUT values (e.g., latch values, signal values, state machine states, etc.).

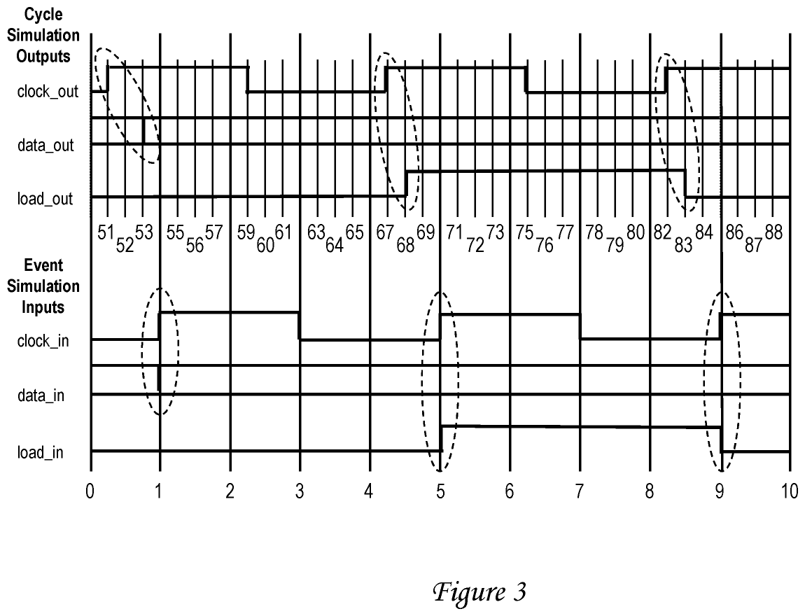

FIG. 3 illustrates an example of the establishment of co-simulation intervals by co-simulation platform 200 in accordance with one embodiment. In the illustrated example, one or more IP blocks within first logic block set 208 generate three output signals, namely, clock_out, data_out, and load_out, which are received by one or more IP blocks within second logic block set 210 as clock_in, data_in, and load_in signals, respectively. State and signal transitions within first logic block set 208 are synchronized with a simulated clock signal provided cycle-based simulator 202 of which a number of clock cycles, arbitrarily labeled cycles 50 to 88, are illustrated. As depicted, the clock_out signal rises on clock cycles 51, 67, and 82, the data_out signal changes state at cycle 53, and the load_out signal changes state at cycles 68 and 83.

In order to exchange simulation values, such as those of clock_out, data_out, and load_out, between first logic block set 208 and second logic block set 210, co-simulation platform 200 preferably aligns processing stages of cycle-based simulator 202 with processing phases of event-based simulator 204. In the depicted example, the processing stages of cycle-based simulator 202 and processing phases of event-based simulator 204 align every four clock cycles of cycle-based simulator 202 at co-simulation intervals arbitrarily labeled 0 to 9. Co-simulation platform 200 can then facilitate the exchange of values modified within a co-simulation interval at the subsequent co-simulation interval boundary. Thus, co-simulation platform 200 facilitates communication of the transitions of clock_out and data_out occurring at clock cycles 51 and 53, respectively, at co-simulation interval 1, the transition of clock_out and load_out occurring at clock cycles 67 and 68, respectively, at co-simulation interval 5, and the transition of clock_out and load_out occurring at clock cycles 82 and 83, respectively, at co-simulation interval 9. Cycle-based simulator 202 and event-based simulator 204 preferably pause simulation during the value exchange, for example, by calling a busy function or raising an objection.

Referring now to FIG. 4, the process architecture of a co-simulation platform 200 in accordance with one embodiment is depicted. In the illustrated example, co-simulation platform 200 includes one or more main co-simulation units 400a, 400b, etc. and multiple client co-simulation units 402a, 402b, etc. Main co-simulation unit(s) 400 are configured to coordinate simulation and facilitate communication between diverse concurrently running simulators, such as cycle-based simulator 202 and event-based simulator 204. In embodiments in which multiple main co-simulation units 400 are implemented, one main co-simulation unit (e.g., co-simulation unit 400a) is the primary co-simulation unit responsible for initiating execution of other main co-simulation units 400 and client co-simulation units 402.

In the depicted example, each main co-simulation unit 400 and each client co-simulation unit 402 includes a co-simulation communicator (CC) process 404 that is configured for inter-process communication (IPC), for example, via a message-passing interface (MPI). In a preferred embodiment, the CC process 404 of each secondary main co-simulation unit 400b is restricted to communicate via IPC with only the CC process 404 of primary main co-simulation unit 400a, but the CC process 404 of each client co-simulation unit 402 is permitted to communicate via IPC with the CC process 404 of primary main co-simulation unit 400a as well as with the CC process 404 of each other client-co-simulation unit 402.

Each main co-simulation unit 400 additionally includes a respective main co-simulation process 408 that implements at least a portion of the functionality of co-simulation platform 200. Each main co-simulation process 408 is configured for IPC with the CC process 404 of its main co-simulation unit 400 via a respective portion of shared memory 406 (rather than a MPI).

As further depicted in FIG. 4, client co-simulation unit 402a includes a cycle-based simulation process 410 that executes cycle-based simulator 202. Cycle-based simulation process 410 is configured for IPC with the CC process 404 of client co-simulation unit 402a via a respective portion of shared memory 406. Similarly, client co-simulation unit 402b includes an event-based simulation process 412 that executes event-based simulator 204. Event-based simulation process 412 communicates with the CC process 404 of client co-simulation unit 402b via its own respective portion of shared memory 406.

Separating the CC process 404 of each client co-simulation unit 402 from the simulation process 410 or 412 as shown in FIG. 4 facilitates the restart of co-simulation from a saved co-simulation state. Because of the process separation, restarting from the saved co-simulation state (as discussed in detail below) does not override the membership of the IPC network between CC processes 404 with the IPC network as it existed prior to saving the co-simulation state.

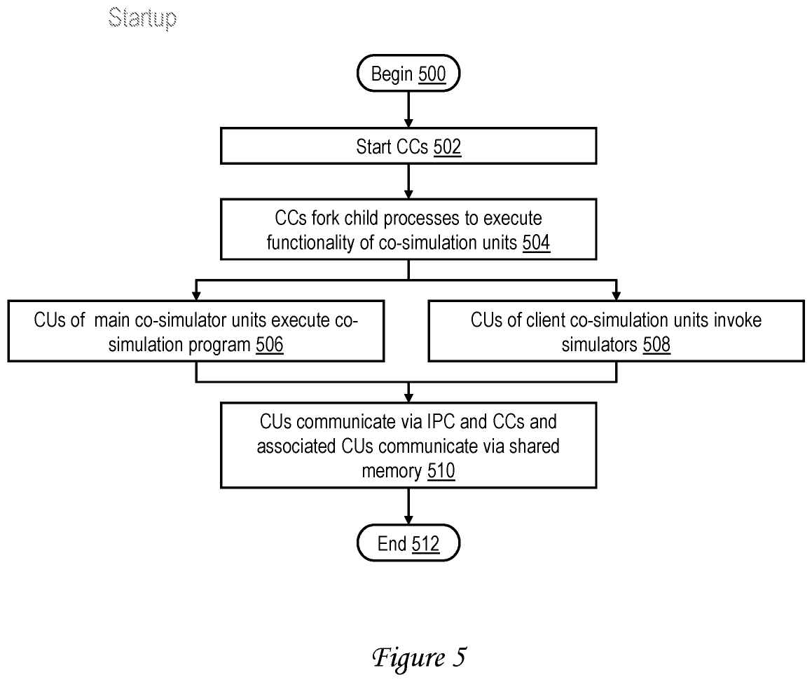

With reference now to FIG. 5, there is a high-level logical flowchart of an exemplary process for starting co-simulation in accordance with one embodiment. The process can be performed, for example, through execution of software by processing circuitry 120 of FIG. 1. For ease of understanding, the process is described with reference to the exemplary process architecture of FIG. 4.

The process of FIG. 5 begins at block 500 and then proceeds to block 502, which illustrates co-simulation platform 200 starting the CC process 404 of each main co-simulation unit 400 of each client co-simulation unit 402. At block 504, each CC process 404 forks a respective process to provide the functionality of its unit 400 or 402. Thus, the CC process 404 of each of main co-simulation unit 400a and secondary main co-simulation unit 400b forks a main co-simulation process 408, and the CC process 404 of each of client co-simulation units 402a, 402b forks a respective one of cycle-based simulation process 410 and event-based simulation process 412. As shown at block 506, main co-simulation processes 408 execute a co-simulation program that coordinates simulation of cycle-based simulator 202 and event-based simulator 204. Concurrently, cycle-based simulation process 410 of client co-simulation unit 402a runs cycle-based simulator 202, and event-based simulation process 412 of client co-simulation unit 402b runs event-based simulator 204 (block 508). During the co-simulation of hybrid DUT model 206, the processes within each co-simulation unit 400 or 402 communicate via shared memory 406, and the co-simulation units 400 and 402 communicate via IPC through CC processes 404 (block 510). The startup process illustrated in FIG. 5 thereafter ends at block 512.

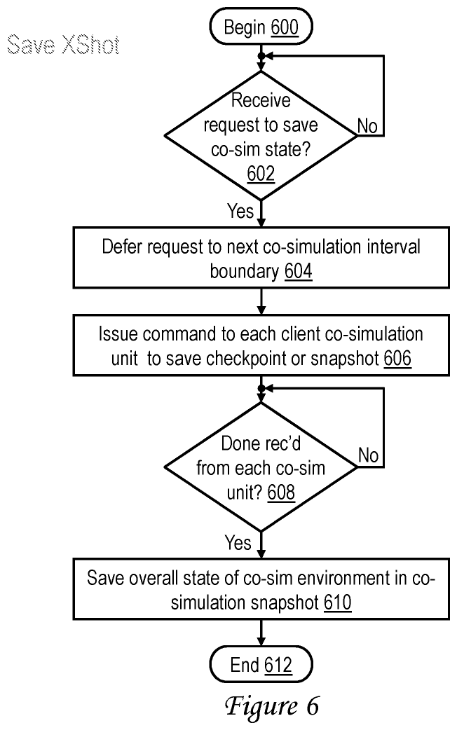

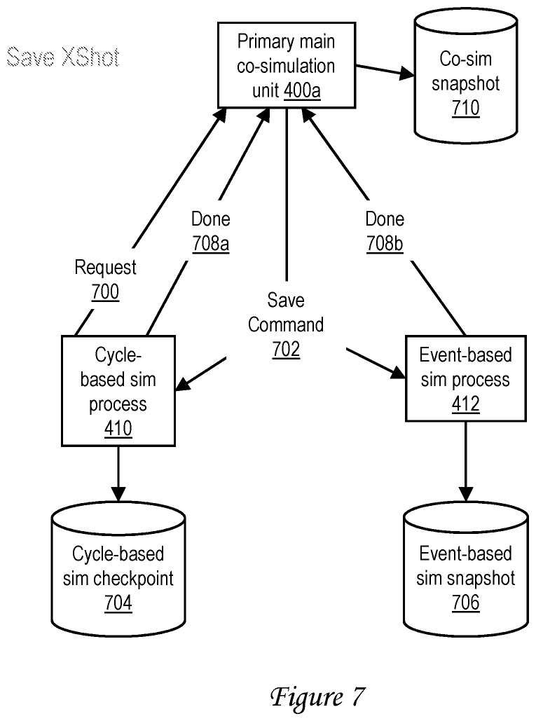

Referring now to FIG. 6, there is depicted a high-level logical flowchart of an exemplary process for saving a co-simulation state in accordance with one embodiment. The process can be performed, for example, through execution by processing circuitry 120 of main co-simulation unit(s) 400 of FIG. 4. To promote understanding, the process of FIG. 6 is described with additional reference to the data flow diagram given in FIG. 7.

The process of FIG. 6 begins at block 600, for example, during co-simulation of hybrid DUT model 206, as previously described, for example, with reference to blocks 506, 508 and 510 of FIG. 5. The process then proceeds to block 602, which illustrates primary main co-simulation unit 400a detecting receipt of a request 700 from one of simulation processes 410 or 412 to save the co-simulation state. This request can be generated, for example, based on an instruction in one of testbenches 212, 214 or based on detection of an event occurrence during simulation (e.g., detection of a logical error). In response to receipt of request 700, primary main co-simulation unit 400a defers servicing request 700 to an immediately following co-simulation interval boundary, as illustrated in FIG. 3 (block 604). At the next co-simulation interval boundary, primary main co-simulation unit 400a issues a save command 702 to each client co-simulation unit 402 to save a checkpoint or snapshot of its respective simulation. It should be noted that differing simulators 202 and 204 can, and often will, implement differing behaviors for saving their respective simulation states. For example, in some cases, a cycle-based simulator 202 responds to the command of primary main co-simulation unit 400a by saving the state of first logic block set 208 (i.e., the portion of hybrid DUT model 206 it controls) in a cycle-based simulation checkpoint 704, but not the state of cycle-based testbench 212. Event-based simulator 204, on the other hand, may save the state of both second logic block set 210 and event-based testbench 214 in an event-based snapshot 706.

At block 608, primary main co-simulation unit 400a verifies whether each client co-simulation unit 402 has saved a checkpoint or snapshot per its save command. For example, primary main co-simulation unit 400a may determine at block 608 whether it has received a done response 708a or 708b to the save command issued at block 606 from each client co-simulation unit 402. In response to an affirmative determination at block 608, primary main co-simulation unit 400a saves the overall state of the co-simulation environment in a co-simulation snapshot file 710 (block 610). The contents of co-simulation snapshot file 710 includes, among other things, identification of the co-simulation interval at which the co-simulation snapshot was captured. Thereafter, the process of FIG. 6 ends at block 612.

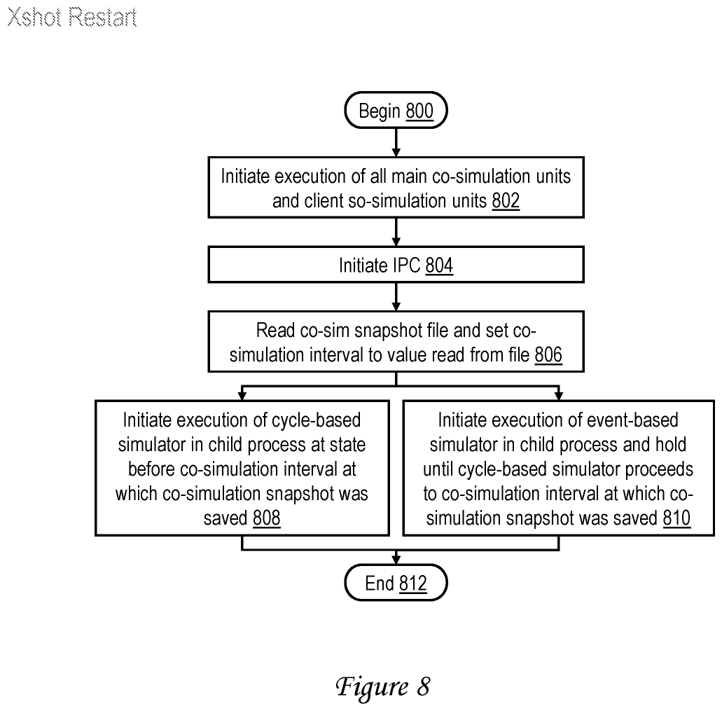

Referring now to FIG. 8, there is depicted a high-level logical flowchart of an exemplary process for restarting a co-simulation from a saved co-simulation state in accordance with one embodiment. The process can be performed, for example, through execution by processing circuitry 120 of co-simulation unit(s) 400 and 402 of FIG. 4.

The process of FIG. 8 begins at block 800 and then proceeds to block 802, which illustrates initiating execution of all main co-simulation units 400a, 400b, etc. and all client co-simulation units 402a, 402b, etc. In at least one implementation, execution of all simulation units 400, 402 can be invoked by a single run command. As discussed above, execution of each co-simulation unit 400 or 402 begins with the CC process 404 of each co-simulation unit 400, which then forks a respective process 408, 410, or 412 that provides the base functionality of the co-simulation unit 400 or 402. The restart process continues at block 804, which illustrates initiating inter-process communication between main co-simulation units 400, between client co-simulation units 402, and between client co-simulation units 402 and primary main co-simulation unit 400a.

Primary main co-simulation unit 400a then reads co-simulation snapshot file 710 and sets the co-simulation interval for the current co-simulation to the specific co-simulation interval recorded in co-simulation snapshot file 710 (block 806). Through IPC, primary main co-simulation unit 400a initiates execution of cycle-based simulator 202 by cycle-based simulation process 410, which as noted above, is a child process of the CC process 404 of client co-simulation unit 402a (block 808). Simulation by cycle-based simulator 202 is restarted based on the state recorded in cycle-based simulation checkpoint 704. As noted in block 808, because cycle-based simulator 202 captures cycle-based simulation checkpoint 704 based on its own internal state and its clock signal, the execution of cycle-based simulator 202 typically begins in the co-simulation interval prior to the co-simulation interval at which the co-simulation snapshot 710 was captured in order to enable cycle-based simulator 202 to achieve the appropriate internal state (e.g., collection of latch values, signal values, state machine states, etc.). Primary main co-simulation unit 400a, via IPC, additionally initiates execution of event-based simulator 204 by event-based simulation process 412 at the co-simulation interval recorded in the co-simulation snapshot file 710 based on the snapshot recorded in event-based simulation snapshot 706 (block 810). As indicated in block 810, primary main co-simulation unit 400a holds execution of event-based simulator 204 at the co-simulation interval read from co-simulation snapshot file 710 until execution of cycle-based simulator 202 reaches that co-simulation interval. Following blocks 808 and 810, co-simulation by cycle-based simulator 202 and event-based simulator 204 proceeds, and the restart process of FIG. 8 ends at block 812.

As has been described, in at least one embodiment, co-simulation of an integrated circuit design is restarted from a co-simulation snapshot. Execution of a respective co-simulation communicator (CC) process for each of a main co-simulation unit, a first client co-simulation unit, and a second client co-simulation unit is initiated. A first child process is forked from the CC process of the first client co-simulation unit, and a second child process is forked from the CC process of the second client co-simulation unit. Via inter-process communication from the CC process of the main co-simulation unit to the CC process of each of the first and second client co-simulation units, coordinated execution of a cycle-based simulator by the first child process and execution of an event-based simulator by the second child process is restarted. Execution of the cycle-based simulator is restarted from a cycle-based simulation checkpoint, and execution of the event-based simulator is restarted from an event-based simulation snapshot.

One advantage of the described process is that the inter-process communication network is established prior to and separately from the processes that run the cycle-based and event-based simulators. Consequently, restarting simulation from a saved state does not result in replacement of or override of the inter-process communication network.

The present invention may be implemented as a method, a system, and/or a computer program product. The computer program product may include a storage device having computer-readable program instructions (program code) thereon for causing a processor to carry out aspects of the present invention. As employed herein, a “storage device” is specifically defined to include only statutory articles of manufacture and to exclude signal media per se, transitory propagating signals per se, and energy per se.

Aspects of the present invention are described herein with reference to flowchart illustrations and/or block diagrams that illustrate the architecture, functionality, and operation of possible implementations of systems, methods, and computer program products according to various embodiments. It will be understood that each block of the block diagrams and/or flowcharts and combinations of blocks in the block diagrams and/or flowcharts can be implemented by special purpose hardware-based systems and/or program code that perform the specified functions. While the present invention has been particularly shown as described with reference to one or more preferred embodiments, it will be understood by those skilled in the art that various changes in form and detail may be made therein without departing from the spirit and scope of the invention.

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that multiple of the disclosed embodiments can be combined. Lastly, the use of a singular term, such as, but not limited to, “a” is not intended as limiting of the number of items.

What is claimed is:

1. A method of data processing in a data processing system, the method comprising:
a processor of the data processing system initiating a restart of a co-simulation of an integrated circuit design from a co-simulation snapshot, wherein the initiating includes initiating a respective co-simulation communicator (CC) process for each of a main co-simulation unit, a first client co-simulation unit, and a second client co-simulation unit;
the processor forking a first child process of the CC process of the first client co-simulation unit and forking a second child process of the CC process of the second client co-simulation unit; and
the processor, via inter-process communication from the CC process of the main co-simulation unit to the respective CC process of each of the first and second client co-simulation units, restarting coordinated execution of a cycle-based simulator by the first child process and execution of an event-based simulator by the second child process, wherein execution of the cycle-based simulator is restarted from a cycle-based simulation checkpoint and execution of the event-based simulator is restarted from an event-based simulation snapshot.

2. The method of claim 1, further comprising:
the processor determining a co-simulation interval from the co-simulation snapshot; and
wherein the restarting coordinated execution includes restarting the cycle-based simulator prior to the determined co-simulation interval and restarting the event-based simulator from the determined co-simulation interval.

3. The method of claim 1, further comprising:
the CC process of the first client co-simulation unit communicating with the first child process via shared memory.

4. The method of claim 1, further comprising:
the processor saving the co-simulation snapshot based on a request from the first process or the second process.

5. The method of claim 4, further comprising:
based on the request, the processor causing the main co-simulation unit to issue a save command to the first process and the second process; and
based on the save command, the first process saving the cycle-based simulation checkpoint and the second process saving the event-based simulation snapshot.

6. The method of claim 1, wherein the processor initiates inter-process communication between the CC processes prior to initiating execution of the cycle-based simulator by the first child process and execution of the event-based simulator by the second child process.

7. A program product, comprising:
a storage device; and
program code within the storage device that, when executed by a processor of a data processing system, causes the processor to perform:
initiating a restart of a co-simulation of an integrated circuit design from a co-simulation snapshot, wherein the initiating includes initiating a respective co-simulation communicator (CC) process for each of a main co-simulation unit, a first client co-simulation unit, and a second client co-simulation unit;
forking a first child process of the CC process of the first client co-simulation unit and forking a second child process of the CC process of the second client co-simulation unit; and
via inter-process communication from the CC process of the main co-simulation unit to the respective CC process of each of the first and second client co-simulation units, restarting coordinated execution of a cycle-based simulator by the first child process and execution of an event-based simulator by the second child process, wherein execution of the cycle-based simulator is restarted from a cycle-based simulation checkpoint and execution of the event-based simulator is restarted from an event-based simulation snapshot.

8. The program product of claim 7, wherein the program code further causes the processor to perform:
determining a co-simulation interval from the co-simulation snapshot;
wherein the restarting coordinated execution includes restarting the cycle-based simulator prior to the determined co-simulation interval and restarting the event-based simulator from the determined co-simulation interval.

9. The program product of claim 7, wherein the program code further causes the processor to perform:
the CC process of the first client co-simulation unit communicating with the first child process via shared memory.

10. The program product of claim 7, wherein the program code further causes the processor to perform:
saving the co-simulation snapshot based on a request from the first process or the second process.

11. The program product of claim 10, wherein the program code further causes the processor to perform:
based on the request, causing the main co-simulation unit to issue a save command to the first process and the second process; and
based on the save command, the first process saving the cycle-based simulation checkpoint and the second process saving the event-based simulation snapshot.

12. The program product of claim 7, wherein inter-process communication between the CC processes is initiated prior to initiating execution of the cycle-based simulator by the first child process and execution of the event-based simulator by the second child process.

13. A data processing system, comprising:
processing circuitry;
a storage device coupled to the processing circuitry; and
program code within the storage device that, when executed by the processing circuitry, causes the processing circuitry to perform:
initiating a restart of a co-simulation of an integrated circuit design from a co-simulation snapshot, wherein the initiating includes initiating a respective co-simulation communicator (CC) process for each of a main co-simulation unit, a first client co-simulation unit, and a second client co-simulation unit;
forking a first child process of the CC process of the first client co-simulation unit and forking a second child process of the CC process of the second client co-simulation unit; and
via inter-process communication from the CC process of the main co-simulation unit to the respective CC process of each of the first and second client co-simulation units, restarting coordinated execution of a cycle-based simulator by the first child process and execution of an event-based simulator by the second child process, wherein execution of the cycle-based simulator is restarted from a cycle-based simulation checkpoint and execution of the event-based simulator is restarted from an event-based simulation snapshot.

14. The data processing system of claim 13, wherein the program code further causes the processing circuitry to perform:
determining a co-simulation interval from the co-simulation snapshot;
wherein the restarting coordinated execution includes restarting the cycle-based simulator prior to the determined co-simulation interval and restarting the event-based simulator from the determined co-simulation interval.

15. The data processing system of claim 13, wherein the program code further causes the processing circuitry to perform:
the CC process of the first client co-simulation unit communicating with the first child process via shared memory.

16. The data processing system of claim 13, wherein the program code further causes the processing circuitry to perform:
saving the co-simulation snapshot based on a request from the first process or the second process.

17. The data processing system of claim 16, wherein the program code further causes the processing circuitry to perform:
based on the request, causing the main co-simulation unit to issue a save command to the first process and the second process; and
based on the save command, the first process saving the cycle-based simulation checkpoint and the second process saving the event-based simulation snapshot.

18. The data processing system of claim 13, wherein inter-process communication between the CC processes is initiated prior to initiating execution of the cycle-based simulator by the first child process and execution of the event-based simulator by the second child process.
